(19) United States
(12) Patent Application Publication
(10) Pub. No.: US 2009/0024774 A1
(43) Pub. Date: Jan. 22, 2009

(54) NETWORK BRIDGE DEVICE AND BUS RESET CONTROL METHOD THEREOF

(75) Inventors: Hyun-ju SHIM, Daejeon (KR); Young-kwang SEO, Seoul (KR); Myeong-wuk JANG, Seoul (KR); Tae-yun AN, Yongin-si (KR); Hyug-rae CHO, Seoul (KR); Hun-gu LEE, Seoul (KR); Du-na OH, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/019,722

(22) Filed: Jan. 25, 2008

(30) Foreign Application Priority Data
Jul. 18, 2007 (KR) 10-2007-0071626

(51) Int. Cl. G06F 13/42

(52) U.S. Cl. 710/105

(57) ABSTRACT

A network bridge device for controlling IEEE 1394 bus reset includes an interface for receiving information relating to devices belonging to a foreign cluster, from the foreign cluster; and a controller for determining whether to reset a bus of a local cluster by comparing the received information with pre-stored information. Accordingly, the bus reset storming between the clusters can be prevented by selectively executing the bus reset of the cluster.

### CROSS-REFERENCE TO RELATED APPLICATIONS

This application claims priority under 35 U.S.C. § 119 (a) from Korean Patent Application No. 10-2007-0071626, filed on Jul. 18, 2007 in the Korean Intellectual Property Office, the entire disclosure of which is incorporated herein by reference.

### BACKGROUND OF THE INVENTION

1. Field of the Invention

Apparatuses and methods consistent with the present invention relate to providing a network bridge device and a bus reset control method thereof, and more particularly, to providing a network bridge device for preventing bus reset storming between network clusters by selectively resetting the bus of an individual cluster, and a bus reset control method of the network bridge device.

2. Description of the Related Art

Recently, IEEE 1394, which is a communication system capable of asynchronous and synchronous transmission, has accelerated the implementation of 1394 based home network.

IEEE 1394 serial bus is internationally standardized and in widespread use as a data exchange bus between terminals in home appliances and computer industries. Specifically, the IEEE 1394 bus standard is ‘IEEE Standard for high performance serial bus, (IEEE) STD 1394-1995’, Institute of Electrical and Electronics Engineers (IEEE), August, 1996, U.S.A. In 2000, its amendment ‘IEEE 1394-2000’ was completed.

The IEEE 1394 bus is a wired bus. Up to 63 stations can participate in the communications through the bus line. A maximum distance between two stations is 4.5 m. However, the bus should be installed in every room of the bus stations, and the maximum distance 4.5 m requires a wireless extension of the IEEE 1394 standard. In response to this, the IEEE 1394.1 was created.

However, a 1394 chip, which functions as the 1394.1 bridge, is defined merely in the standard specification but is not yet commercialized because its practical development has not been realized. To utilize the IEEE 1394 bridge in the IEEE 1394 network, a 1394 bridge chip which functions as the 1394.1 bridge should be developed.

According to the IEEE 1394 specification and the IEEE 1394.1 bridge specification, the IEEE 1394.1 bridge is not compatible with IEEE 1394 devices. Hence, in the IEEE 1394 home network which uses the IEEE 1394.1 bridge, smooth home networking is not accomplished unless the IEEE 1394 devices, for example, IEEE 1394-2000 devices have the bridge awareness function for the IEEE 1394.1 bridge.

For the bridge awareness, a related art network bridge device provides a function of allowing a network bridge device of a local cluster to proxy devices of a foreign cluster using a service discovery scheme.

When a bus reset occurs in the local cluster, the 1394 network bridge device using the service discovery scheme determines the change in information due to the reset and accordingly sends the updated information to the network bridge device of the foreign cluster. The cluster, receiving the information, re-sends the updated information to the foreign cluster after the bus reset occurs. As a result, a bus reset storm, which loops the bus reset between the clusters, occurs.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention has been provided to solve the above-mentioned and/or other problems and disadvantages and an aspect of the present invention provides a network bridge device for preventing a bus rest storming between clusters by selectively resetting the bus of the cluster, and a bus reset control method of the network bridge device.

According to an aspect of the present invention, there is provided a network bridge device including an interface which receives information related to devices belonging to a foreign cluster, from the foreign cluster; and a controller which determines whether to reset a bus of a local cluster by comparing the received information with pre-stored information.

The network bridge device may further include a storage which associates and stores information related to local devices in the local cluster, information related to foreign devices in a foreign cluster, and Internet Protocols (IP) addresses of network bridge devices of the clusters. The controller may reset a bus of the local cluster when the information are different from each other.

The controller may examine whether the stored information related to the local devices has changed when the local bus in the local cluster is reset, and the controller may update the stored information when the information related to the local devices has changed.

The controller may send a message including the updated information of the local device to the connected foreign cluster.

When the local bus in the local cluster is reset, the controller may update the stored information and send a message including the updated information to the connected foreign cluster.

The local bus reset may occur when the device in the local cluster is changed or after predetermined periods.

The foreign cluster and the local cluster may communicate according to IEEE 1394 standard.

According to an aspect of the present invention, there is provided a bus reset control method of a network bridge device connected to a foreign cluster through a wireless interface, including receiving information related to devices belonging to the foreign cluster; and determining whether to reset a bus of the local cluster by comparing the received information with pre-stored information.

The bus reset control method may further include resetting a bus of the local cluster when the information are different from each other.

The bus reset control method may further include updating information by determining whether pre-stored information is changed when the local bus reset is executed in the local cluster.

The bus reset control method may further include sending a message including the updated device information to the connected foreign cluster.

The bus reset control method may further include updating pre-stored device information when a local bus reset is executed in the local cluster; and sending a message including the updated information to the connected foreign cluster.

The local bus reset may occur when the device in the local cluster is changed or after predetermined periods.

The foreign cluster and the local cluster may communicate according to the IEEE 1394 standard.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a diagram of IEEE 1394 network which adopts a network bridge device according to an exemplary embodiment of the present invention;

FIG. 2 is a block diagram of the network bridge device according to an exemplary embodiment of the present invention;

FIG. 3 is a flowchart outlining a reset control method of the network bridge device according to an exemplary embodiment of the present invention;

FIG. 4 is a flowchart outlining a local reset control method of a foreign device;

FIGS. 5 and 6 are flowcharts outlining an information transmission method of a local device; and

FIG. 7 is a flowchart outlining a reset control method of the network bridge device according to another exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

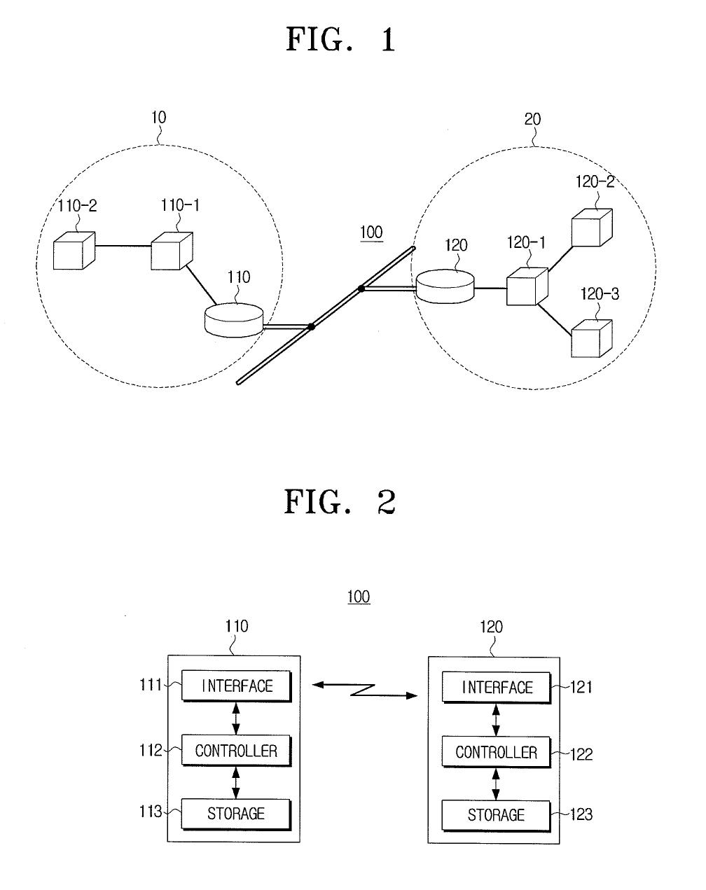

FIG. 1 depicts an IEEE 1394 network which adopts a general network bridge device. The IEEE 1394 (hereafter, referred to as 1394) network of FIG. 1 includes a first cluster 10 and a second cluster 20.

The first cluster 10 is a network group constituted by interconnecting devices 110-1 and 110-2 using a first network bridge device 110. The second cluster 20 is a network group constituted by interconnecting devices 120-1, 120-2 and 120-3 using a second network bridge device 120.

The network bridge devices 110 and 120 and the corresponding devices 110-1, 110-2, 120-1, 120-2 and 120-3 are connected using 1394 cables. The first network bridge device 110 and the second network bridge device 120 communicate data using wired communication using a coaxial cable, power line communication (PLC), wireless local area network (LAN) communication, and Ethernet CAT-5 communication.

The devices 110-1, 110-2, 120-1, 120-2 and 120-3 can be electronic products such as monitors, televisions (TVs), video cassette recorders (VCRs), refrigerators, camcorders, set-top boxes, digital video device (DVD) players, personal computers (PCs), digital cameras, printers, and fax machines.

The devices 110-1, 110-2, 120-1, 120-2 and 120-3, the first and second network bridge devices 110 and 120, and the 1394 cable support the 1394 standard.

If the 1394 network is applied to a home network, the first cluster 10 and the second cluster 20 can be in separate locations such as different rooms in a house and the 1394 network can provide a room-to-room service. The room-to-room service enables one device in the first cluster 10 to share data and contents by communicating with another device in the second cluster 20.

The 1394 network is not limited to the home network and may be applicable to an intranet or a network established between buildings. The number of clusters and the number of devices in FIG. 1 are not limited to those shown in FIG. 1.

FIG. 2 is a block diagram of the network bridge device according to an exemplary embodiment of the present invention. The first network bridge device 110 of FIG. 2 includes an interface 111, a controller 112, and a storage 113. The second network bridge device 120 and any other network bridge device connected to the 1394 home network can have a similar structure.

The first network bridge device 110 may be a local network bridge device which receives information from the second network bridge device 120 and the second network bridge device 120 is a foreign network bridge device by way of example.

The bus reset of the network bridge devices 110 and 120 may be classified as either a local reset due to a change of the local device (hereafter, referred to as a first bus reset), and a bus reset due to a change of the foreign device (hereafter, referred to as a second bus reset).

The bus reset can occur when a device in the cluster is eliminated or added. The reset can be performed by periods for the bus management or when there is no change over a certain time.

Referring to FIGS. 1 and 2, the interface 111 receives a reset message including information related to the devices 120-1, 120-2 and 120-3 of the foreign cluster 20, from the foreign cluster 20.

The received reset message can be a routing table which defines information of every device connected to a network 100. The received reset message defines the functions of the devices 120-1, 120-2 and 120-3 of the foreign cluster 20 as their unique information using a CEA-2070 file.

The storage 113 associates and stores information related to the local devices 110-1 and 110-2 of the local cluster 10, the information related to the foreign devices 120-1, 120-2 and 120-3 of the foreign cluster 20, and IP addresses of the network bridge devices 110 and 120 of the respective clusters.

The controller 112 works based on a High-Definition Audio-Video Network Alliance (HANA) application. After resetting according to the IEEE 1394 specification has occurred, the controller 112 shares the unique information with the first device 110-1 and the second device 110-2 using the CEA-2027 file of the HANA application.

When information is received from the network bridge device 120 of the foreign cluster 20, the controller 112 determines whether to execute the second bus reset in the local cluster by comparing the received information with pre-stored information.

When the received information and the pre-stored information are different from each other, the controller 112 resets the bus of the local cluster. When the information matches, the controller 112 does not reset the bus.

When the local bus is reset in the local cluster, that is, when the first bus reset occurs, the controller 112 examines whether the information of the local devices 110-1 and 110-2 stored in the storage 113 has changed or not. When the information has changed, the controller 112 updates the information.

In the first bus reset, the controller 112 can send the information to the foreign cluster 20 in two manners.

In the first manner, after the first bus reset, the controller 112 examines whether the information of the local devices stored in the storage 113 is changed or not. When the information has changed, the controller 112 updates the information and sends a message including the updated information of the local devices to the foreign cluster 20 connected to the network 100.

In the second manner, after the first bus reset, the controller 112 updates the information and sends the updated information to the foreign cluster 20 connected to the network 100.

The second network bridge device 120 determines whether to execute the second bus reset using the information received from the first network bridge device 110. In doing so, the second cluster 20 becomes the local cluster and the first cluster 10 becomes the foreign cluster.

In the first manner, a controller 122 of the second network bridge device 120 compares the information to determine whether to execute the second bus reset. At this time, since the information matches, the bus is not reset.

In the second manner, since the local reset is generated, the second network bridge device 120 re-sends the information to the first network bridge device 110. Afterwards, the first network bridge device 110 does not execute the first bus reset because the information matches.

As such, the bus reset storming can be avoided by resetting the bus based on a comparison of received information and pre-stored information.

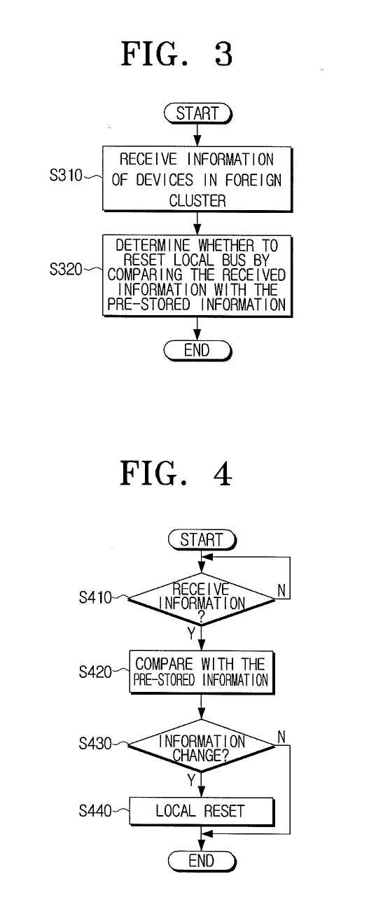

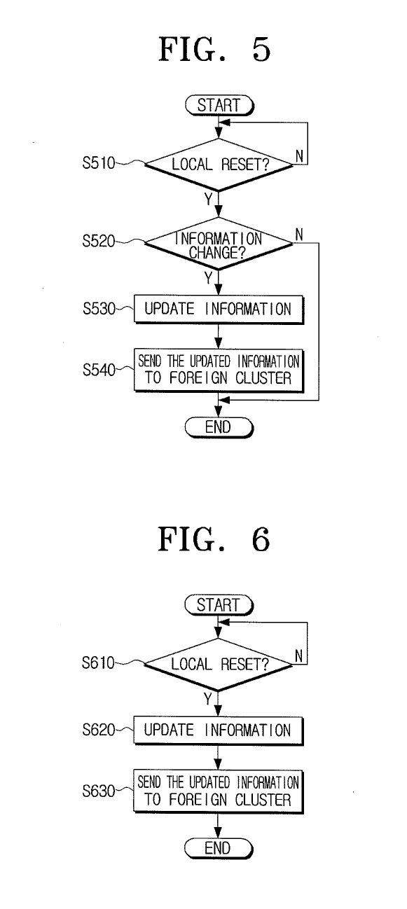

FIG. 3 is a flowchart outlining a reset control method of the network bridge device according to an exemplary embodiment of the present invention. After receiving information related to devices belonging to the foreign cluster (S310), the network bridge device determines whether to execute the local reset, that is, the second bus reset by comparing the received information with pre-stored information (S320). Whether to execute the first bus reset according to the second bus reset can be determined as in FIG. 4, and whether to execute the second bus reset according to the first bus reset can be determined as in FIG. 5 or 6.

In more detail, by means of an if-clause, when the device change of the local cluster or a the periodic reset occurs, whether to reset the bus (the second bus reset) is determined by selecting either FIG. 5 or FIG. 6. When the device change of the foreign cluster and the local reset according to the periodic reset occurs, whether to reset the bus (the first bus reset) is determined by selecting FIG. 4.

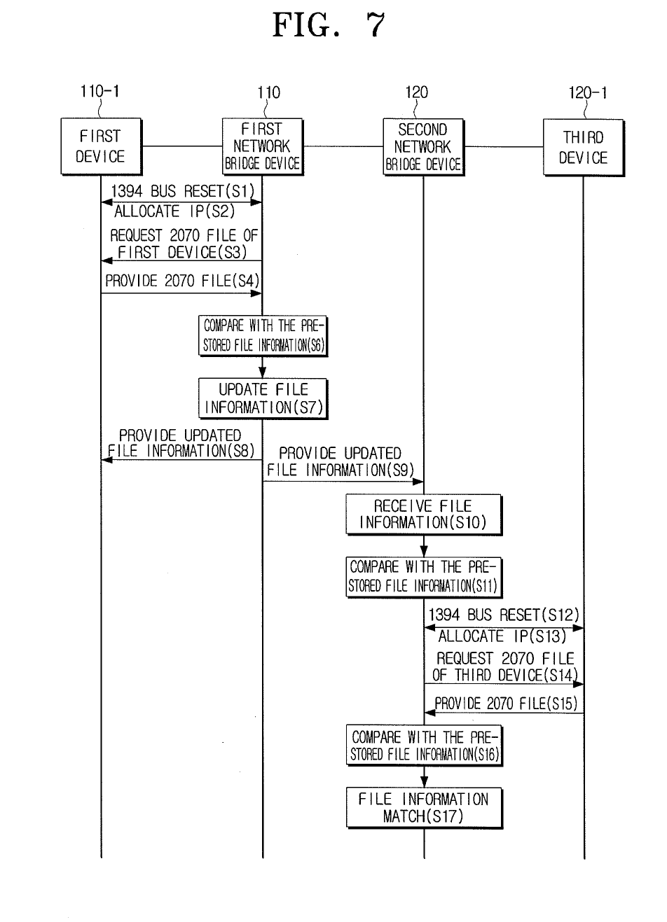

FIG. 7 is a flowchart outlining a reset control method of the network bridge device according to another exemplary embodiment of the present invention. FIG. 7 outlines the method for determining whether to execute the second bus reset and whether to execute the first bus reset at the second network bridge device 120 when the first bus reset occurs in the first network bridge device 110.

Referring now to FIGS. 1 and 7, the case where the second device 110-2 connected to the first network bridge device 110 is eliminated is illustrated. Only the third device 120-1 is described, as the devices connected to the second network bridge device 120 are not changed at all.

When the 1394 bus reset occurs in the local cluster because of the eliminated second device 110-2 (S1), the first network bridge device 110 allocates IP addresses to the local devices of the local cluster 10 in order (S2). The first network bridge device requests the CEA 2070 file of the first device 110-1 (S3) and receives the CEA 2070 file which defines the unique function of the first device 110-1 (S4). When there exists the connected device, S3 and S4 are repeated.

Next, by comparing the received CEA 2070 file with the pre-stored file information (S6), the first network bridge device 110 updates the pre-stored file information when the received file information is changed (S7).

The first network bridge device 110 provides the updated file information to the devices within the cluster (S8). The first network bridge device 110 provides the updated file to the second network bridge device 120 (S9).

Note that S1 through S9 follow the method of FIG. 5 when the first bus reset occurs.

Upon receiving the file information from the first network bridge device 110 (S10), the second network bridge device 120 compares the received file information with pre-stored file information (S11). When the received information is changed, the second network bridge device 120 performs the second bus reset.

Note that S10, S11, and S12 follow the method of FIG. 4 for the second bus reset.

When the 1394 bus is reset (S12), the second network bridge device 120 requests a CEA 2070 file of the local devices of the second cluster (S14). When receiving the requested CEA 2070 file (S15), the second network bridge device 120 compares the received CEA 2070 file information with pre-stored file information (S16). Since the received CEA 2070 file information and the pre-stored information match (S17), the first bus reset is not executed.

Herein, S12 through S17, which correspond to the bus reset in the local, are performed as in FIG. 5. The reset determination method is selected depending on whether the reset is performed by the local cluster or the foreign cluster, and whether to reset the bus is determined based on the information comparison. Thus, the bus reset storming can be prevented.

In the light of the foregoing, when the bus reset occurs in the local cluster, the updated information is sent to the foreign cluster. When information is received from the foreign cluster, whether to reset the bus is determined by checking the information change. By selectively executing the bus reset of the cluster, the bus reset storming between the clusters can be avoided.

Although a few exemplary embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A network bridge device comprising:
an interface which receives information relating to at least one of foreign device belonging to a foreign cluster, from the foreign cluster; and
a controller which determines whether to reset a bus of a local cluster by comparing the received information with pre-stored information.

2. The network bridge device of claim 1, further comprising:
a storage which associates and stores information relating to at least one local device in the local cluster, information relating to the at least one foreign device in the foreign cluster, an Internet Protocol (IP) address of a network bridge device of the local cluster and an IP address of a network bridge device of the foreign cluster,
wherein the controller resets the bus of the local cluster if the information relating to the at least one local device in the local cluster, the information relating to the at least one foreign device in the foreign cluster, and at least one of the IP addresses of the network bridge devices of the local cluster and the foreign cluster are different from each other.

3. The network bridge device of claim 2, wherein the controller determines whether the stored information relating to the at least one local device has changed if the bus of the local cluster is reset, and the controller updates the information relating to the at least one local device if the information is changed.

4. The network bridge device of claim 3, wherein the controller sends a message including the updated information relating to the at least one local devices to the foreign cluster.

5. The network bridge device of claim 2, wherein, if the bus of the local cluster is reset, the controller updates the information relating to the at least one local device in the local cluster, the information relating to the at least one foreign device in the foreign cluster, and the IP addresses of the network bridge devices of the local cluster and the foreign cluster and sends a message including the updated information relating to the at least one local device in the local cluster, the information relating to the at least one foreign device in the foreign cluster, and the IP addresses of the network bridge devices of the local cluster and the foreign cluster, to the foreign cluster.

6. The network bridge device of claim 5, wherein the local bus is reset either if the at least one of the local devices in the local cluster has changed or after a predetermined period.

7. The network bridge device of claim 1, wherein the foreign cluster and the local cluster communicate according to IEEE 1394 standard.

8. A bus reset control method of a network bridge device connected to a foreign cluster through a wireless interface, the method comprising:
receiving information relating to devices belonging to the foreign cluster; and
determining whether to reset a bus of a local cluster by comparing the received information with pre-stored device information.

9. The bus reset control method of claim 8, further comprising:
resetting the bus of the local cluster if the received information is different from the pre-stored device information.

10. The bus reset control method of claim 8, further comprising:
if the local bus is reset in the local cluster, updating the received information by determining whether the pre-stored device information has changed.

11. The bus reset control method of claim 10, further comprising:
sending a message including the updated device information to the foreign cluster.

12. The bus reset control method of claim 8, further comprising:
if the local bus is reset in the local cluster, updating the pre-stored device information; and
sending a message including the updated pre-stored device information to the foreign cluster.

13. The bus reset control method of claim 12, wherein the local bus reset occurs either if at least one of the local devices in the local cluster have changed or after a predetermined period.

14. The bus reset control method of claim 8, wherein the foreign cluster and the local cluster communicate according to IEEE 1394 standard.
